(19) United States
(12) Patent Application Publication
(10) Pub. No.: US 2026/0279640 A1
(43) Pub. Date: Sep. 17, 2026

(54) INDUCTOR COMPONENT

(71) Applicant: Murata Manufacturing Co., Ltd., Kyoto-fu (JP)

(72) Inventors: Yoshimasa YOSHIOKA, Nagaokakyo-shi (JP); Yuuki KAWAKAMI, Nagaokakyo-shi (JP); Kojiro KOMAGAKI, Nagaokakyo-shi (JP); Masashi HATTORI, Nagaokakyo-shi (JP)

(73) Assignee: Murata Manufacturing Co., Ltd., Kyoto-fu (JP)

(21) Appl. No.: 19/671,366

(22) Filed: May 8, 2026

Related U.S. Application Data
(63) Continuation of application No. PCT/JP2024/019707, filed on May 29, 2024.

(30) Foreign Application Priority Data
Nov. 9, 2023 (JP) 2023-191720

(51) Int. Cl. H01F 17/00; H01F 27/29

(52) U.S. Cl. CPC H01F 17/0013; H01F 27/292; H01F 2017/002; H01F 2017/0053; H01F 2017/0066; H01F 2017/0073; H01F 2017/0086

(57) ABSTRACT

An inductor component that includes an inductor wiring extending along a plane; pad portions at two ends of the inductor wiring; perpendicular wirings extending perpendicularly to the plane from the pad portions; and a first magnetic layer and a second magnetic layer that hold the inductor wiring therebetween. The first magnetic layer and the second magnetic layer have uniaxial magnetic anisotropy axes oriented in the same axial direction, and the inductor wiring extends throughout an entire area in a direction not orthogonal to a first one of the anisotropy axes (X-axis). A magnetic flux caused by the inductor wiring can thus be oriented along a first one of the anisotropy axes, and the effect of a second one of the anisotropy axes can be reduced.

### CROSS-REFERENCE TO RELATED APPLICATIONS

This application claims benefit of priority to International Patent Application No. PCT/JP2024/019707, filed May 29, 2024, and to Japanese Patent Application No. 2023-191720, filed Nov. 9, 2023, the entire contents of each are incorporated herein by reference.

### BACKGROUND

### Technical Field

The present disclosure relates to an inductor component including an inductor wiring extending in a plane shape.

### Background Art

Inductor components including an inductor wiring extending in a plane shape have become widespread. Some of such inductor components include a line including an inductor wiring covered with a layer having uniaxial magnetic anisotropy as described, for example, in Japanese Unexamined Patent Application Publication No. 2014-199902. The line described in Japanese Unexamined Patent Application Publication No. 2014-199902includes an inductor wiring in which a long side portion and a short side portion perpendicular to each other are connected in series, and the long side portion and the short side portion are arranged to be parallel to two anisotropy axes in uniaxial magnetic anisotropy. For example, a magnetic flux caused by the inductor wiring at the long side portion can thus be oriented in a first one of the anisotropy axes, and improvement in inductance acquisition efficiency or direct current superimposition characteristics can be expected.

### SUMMARY

However, the long side portion and the short side portion are perpendicular to each other, and thus, the magnetic flux caused by the inductor wiring at the short side portion is concurrently oriented along a second anisotropy axis. The effect of the first anisotropy axis is thus reduced by the effect of the second axis, and the desired characteristics may be difficult to achieve.

The present disclosure thus aims to provide an inductor component that allows a magnetic flux caused by an inductor wiring to be oriented along a first anisotropy axis while reducing the effect of a second anisotropy axis.

An inductor component according to an aspect of the present disclosure includes an inductor wiring extending along a plane; pad portions located at two ends of the inductor wiring; perpendicular wirings extending perpendicularly to the plane from the pad portions; and a first magnetic layer and a second magnetic layer that hold the inductor wiring therebetween. The first magnetic layer and the second magnetic layer have uniaxial magnetic anisotropy axes that are oriented in the same direction. The inductor wiring extends throughout an entire area in a direction not orthogonal to a first one of the uniaxial magnetic anisotropy axes.

According to the present disclosure, an inductor wiring extends between two ends spaced apart in a first one of the anisotropy axes, and a large part of a magnetic flux is oriented in a direction of a second one of the anisotropy axes. The present disclosure can thus achieve an effect resulting from orienting the magnetic flux in a direction of the second anisotropy axis. At the same time, the inductor wiring extends throughout an entire area in a direction not orthogonal to the first anisotropy axis. The present disclosure can thus reduce the effect of the first anisotropy axis. The present disclosure can thus reliably achieve an effect such as improvement in inductance acquisition efficiency (when the second anisotropy axis is an easy axis), improvement in direct current superimposition characteristics, or reduction of iron losses (when the second anisotropy axis is a hard axis). In addition, an inductor component is connected to an external circuit through perpendicular wirings, and thus can be efficiently mounted.

### BRIEF DESCRIPTION OF THE DRAWINGS

FIG. 1 is a schematic plan view of an inductor component according to a first embodiment of the present disclosure;

FIG. 2 is a side cross-sectional view taken along line A-A in FIG. 1;

FIG. 3 is a graph describing a B-H curve (magnetic hysteresis curve) and including an easy axis and a hard axis;

FIG. 4A is a schematic diagram describing a method for manufacturing the inductor component according to the first embodiment of the present disclosure, and is a side view describing a process 1 of preparing a substrate material;

FIG. 4B is a side view describing a process 2, following the process 1, of laminating a first magnetic layer on the substrate material;

FIG. 4C is a side view describing a process 3, following the process 2, of laminating a first insulating layer on the first magnetic layer;

FIG. 4D is a side view describing a process 4, following the process 3, of forming an inductor wiring on the first insulating layer;

FIG. 4E is a side view describing a process 5, following the process 4, of laminating a second insulating layer on the first insulating layer on which the inductor wiring is disposed;

FIG. 4F is a side view describing a process 6, following the process 5, of laminating a second magnetic layer on the second insulating layer;

FIG. 4G is a side view describing a process 7, following the process 6, of forming via holes on the surface of the second magnetic layer;

FIG. 4H is a side view describing a process 8, following the process 7, of forming perpendicular wirings in the via holes;

FIG. 4J is a side view describing a process 9, following the process 8, of grinding the substrate material into a substrate with a predetermined thickness;

FIG. 4K is a side view describing a process 10, following the process 9, of dicing using cutting means;

FIG. 4L is a side view of an inductor component formed by dicing in the process 10;

FIG. 5 is a schematic plan view of an inductor component according to a modification example 1 of the first embodiment of the present disclosure;

FIG. 6 is a side cross-sectional view taken along line B-B in FIG. 5;

FIG. 7 is a schematic side cross-sectional view of an inductor component according to a modification example 2 of the first embodiment of the present disclosure;

FIG. 8 is a schematic side cross-sectional view of an inductor component according to a modification example 3 of the first embodiment of the present disclosure;

FIG. 9 is a schematic plan view of an inductor component according to a second embodiment of the present disclosure;

FIG. 10A is a side cross-sectional view taken along line C-C in FIG. 9;

FIG. 10B is a side cross-sectional view taken along line D-D in FIG. 9;

FIG. 11A is a schematic diagram of an inductor component according to a modification example 1 of the second embodiment of the present disclosure, and is a side cross-sectional view taken along the same plane as that in FIG. 10A;

FIG. 11B is a schematic diagram of an inductor component according to the modification example 1 of the second embodiment of the present disclosure, and is a side cross-sectional view taken along the same plane as that in FIG. 10B;

FIG. 12 is a schematic diagram of an inductor component according to a modification example 2 of the second embodiment of the present disclosure, and is a side cross-sectional view taken along the same plane as that in FIG. 10B;

FIG. 13 is a schematic plan view of an example of an inductor component including multiple inductor wirings disposed along a plane;

FIG. 14 is a schematic diagram of an inductor component according to a third embodiment of the present disclosure, and is a side cross-sectional view taken along the same plane as that in FIG. 10B; and

FIG. 15 is a schematic diagram of an inductor component according to a fourth embodiment of the present disclosure, and is a side cross-sectional view taken along the same plane as that in FIG. 2.

### DETAILED DESCRIPTION

Hereinafter, embodiments and modification examples of the present disclosure will be described with reference to the drawings. In the drawings, corresponding components having the same functions are denoted by the same reference signs. For convenience of explanation and ease of understanding, the embodiments may be separately illustrated. However, the components described in different embodiments may be partially replaced with or combined with each other. In the embodiments described below, descriptions of matters common to the embodiments may be omitted, and only differences will be explained. In particular, similar advantageous effects obtained by similar configurations will not be repeatedly described for each embodiment. The sizes and positional relationships of the members illustrated in the drawings may be exaggerated for clarity of explanation.

In the drawings, an inductor component having a substantially rectangular prism profile is mounted on a horizontal surface while having a substrate facing down, a longitudinal direction aligned with an X-axis, a cross direction aligned with a Y-axis, and a height direction perpendicular to these directions aligned with a Z-axis. (Inductor Component According to First Embodiment of Present Disclosure)

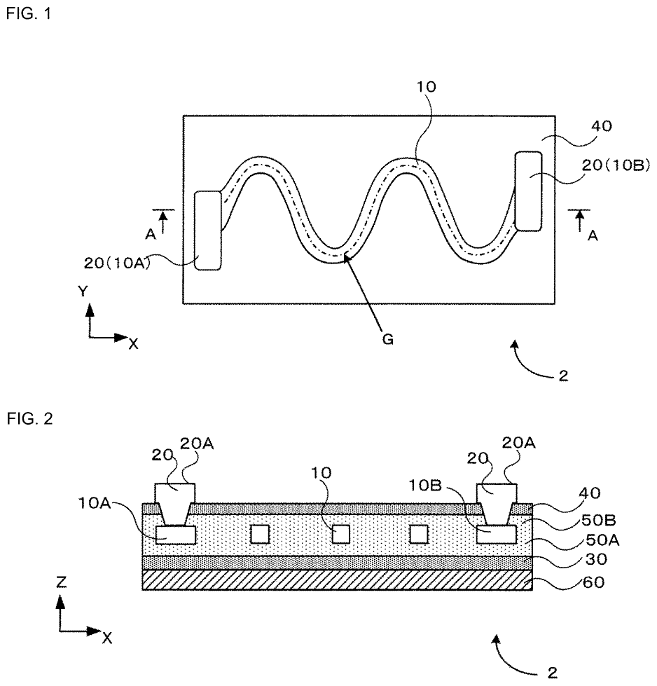

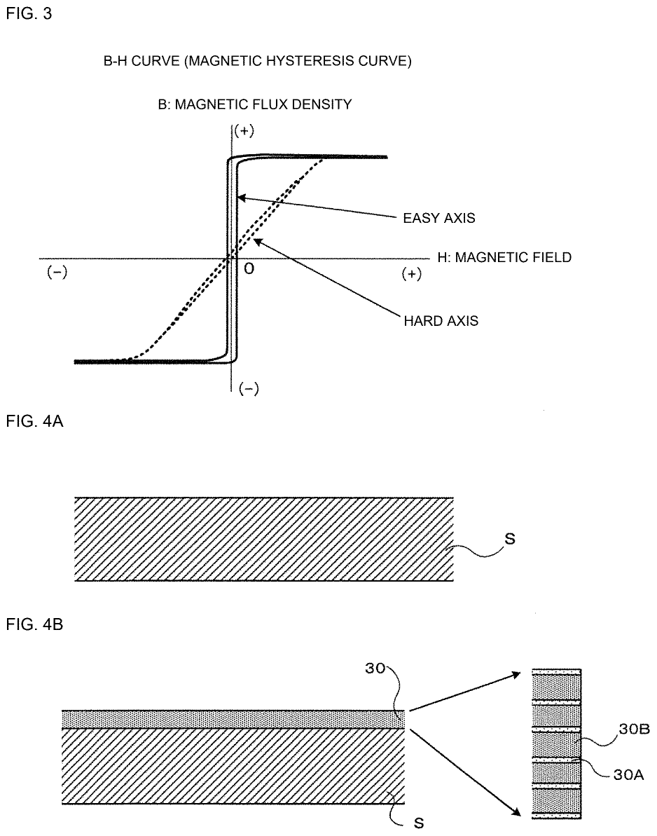

First, with reference to FIG. 1 to FIG. 3, an inductor component according to a first embodiment of the present disclosure is described. FIG. 1 is a schematic plan view of the inductor component according to the first embodiment of the present disclosure. FIG. 2 is a side cross-sectional view taken along line A-A in FIG. 1. FIG. 3 is a graph of a B-H curve (magnetic hysteresis curve) including an easy axis and a hard axis. In FIG. 1, the inductor wiring is drawn with solid lines in perspective.

In an inductor component 2 according to the present embodiment, a first magnetic layer 30 is disposed on a substrate 60, a first insulating layer 50A is disposed on the first magnetic layer 30, an inductor wiring 10 and a second insulating layer 50B covering the first insulating layer 50A are disposed on the first insulating layer 50A, and a second magnetic layer 40 is disposed on the inductor wiring 10 and the second insulating layer 50B. The inductor wiring 10 extends along a plane, and includes pad portions 10A and 10B at both ends. From the pad portions 10A and 10B at both ends, perpendicular wirings 20 extend perpendicularly to the plane along which the inductor wiring 10 extends. In the inductor component 2 according to the present embodiment, the inductor wiring 10 is disposed between the first magnetic layer 30 and the second magnetic layer 40 in the Z-axis direction.

In the present embodiment, a high-resistivity silicon substrate is used as the substrate 60. However, this is not a limited example, and any other inorganic substrate such as a glass substrate or a ceramic substrate may be employed as the substrate 60. Preferably, a highly insulative substrate is used in view of reduction of an occurrence of eddy currents. The substrate 60 may have a thickness of, for example, 5 μm, but the thickness is not limited to this example. In the present embodiment, layers forming the inductor component 2 including the first magnetic layer 30 are formed on the inorganic substrate. Even when the substrate 60 is thin, the substrate 60 can thus ensure chip strength.

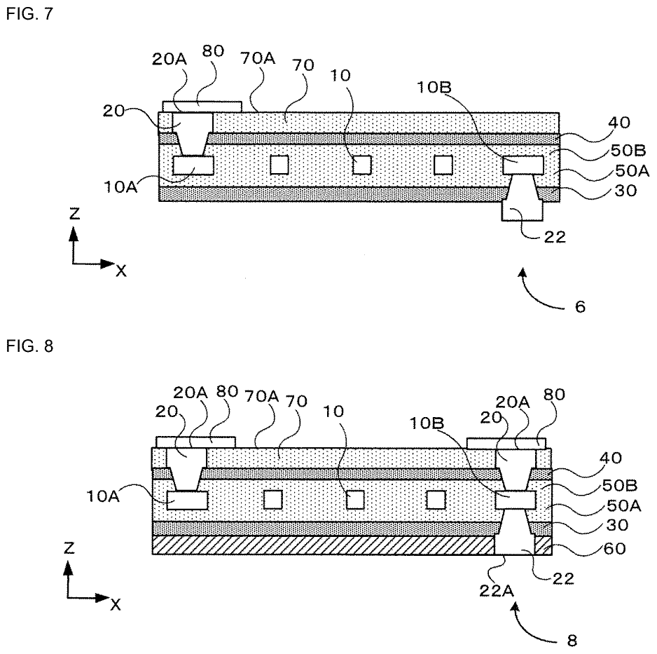

However, as described later with reference to FIG. 7, an inductor component 6 including no substrate 60 may be used. Alternatively, an organic insulating layer may be disposed between the substrate 60 and the first magnetic layer 30.

The first magnetic layer 30 and the second magnetic layer 40 are each formed from a laminate body including inorganic insulating layers and inorganic magnetic layers. The thickness of the first magnetic layer 30 and the second magnetic layer 40 may be, for example, approximately 5 to 6 μm, but is not limited to this example. The materials and the detail structures of the first magnetic layer 30 and the second magnetic layer 40 are described later in detail in the description of a manufacturing method.

In the present embodiment, the first insulating layer 50A and the second insulating layer 50B are formed from polyimide. However, the material is not limited to this example, and may be another organic resin such as epoxy or phenol, or a combination of these, or may include an insulating filler. Alternatively, the first insulating layer 50A and the second insulating layer 50B may be formed from an inorganic insulating material such as SiO₂ or TaO. In the present embodiment, the thickness of the first insulating layer 50A is, for example, 5 μm, but the thickness is not limited to this example. The thickness of the second insulating layer 50B is a value obtained by adding approximately 2 to 10 μm to the thickness of the inductor wiring 10.

The perpendicular wirings 20 and the inductor wiring 10 including the pad portions 10A and 10B at both ends are formed from an electroconductive material with a small electric resistance such as copper, silver, or gold. Preferably, the perpendicular wirings 20 and the inductor wiring 10 are formed from a conductor containing copper or a copper compound. The perpendicular wirings 20 are electrically connected to the inductor wiring 10 through the pad portions 10A and 10B at both ends. In the present embodiment, a flat wiring with cross-sectional dimensions of 40 μm×20 μm is used as the inductor wiring 10, but the material is not limited to this example. A flat wiring with different dimensions may be used, or a wiring other than a flat wiring may be used.

The length of the perpendicular wirings 20 in the perpendicular direction is determined by thicknesses of the second insulating layer 50B and the second magnetic layer 40 and the dimension by which the perpendicular wirings 20 protrude from the surface of the second magnetic layer 40. In the present embodiment, the dimension by which the perpendicular wirings 20 protrude from the surface of the second magnetic layer 40 is 5 μm, but the dimension is not limited to this example.

The inductor component 2 with the above structure has a substantially rectangular prism profile, and has dimensions L×W×T of 1.0 mm×0.5 mm×0.5 mm where the dimension in the longitudinal direction (X-axis direction) is denoted by L, the dimension in the cross direction (Y-axis direction) is denoted by W, and the dimension in the height direction (Z-axis direction) is denoted by T. However, this is a mere example, and an inductor component with an outer periphery having other dimensions may be used.

When the perpendicular wirings 20 that protrude from the surface of the second magnetic layer 40 are electrically connected to an external circuit, a current is passed to the inductor wiring 10 through the perpendicular wirings 20 to generate a magnetic flux, to cause the inductor component to function as an inductor.

As illustrated in FIG. 2, the perpendicular wirings 20 according to the present embodiment each have a cross-sectional area that increases from the end surfaces that are in contact with the pad portions 10A and 10B toward opposite end surfaces 20A. At the end surfaces 20A, the connection strength of the perpendicular wirings 20 with an external circuit or an external terminal thus improves, and connection electric resistance can be reduced.

In the present embodiment, as illustrated in FIG. 2, the perpendicular wirings 20 extend through the second magnetic layer 40. As described above, in a plan view, the second magnetic layer 40 is disposed to cover the entire periphery of the perpendicular wiring 20, and the area of the second magnetic layer 40 is maximized in directions of the plane. Inductor acquisition efficiency can thus be improved, and magnetic flux leakage can be reduced.

The inductor component 2 according to the present embodiment further includes multiple conductive layers at the end surfaces 20A of the perpendicular wirings 20. For example, when Ni layers are formed at the end surfaces 20A to serve as the conductive layers, electromigration resistance can be provided, and when, for example, Au layers or Sn layers are formed at the end surfaces 20A to serve as the conductive layers, solder wettability can be provided. Functions appropriate to the connection to an external circuit can thus be provided.

### <Extension Direction of Inductor Wiring>

The inductor component 2 having a substantially rectangular prism profile includes the pad portions 10A and 10B in areas at both ends in the longitudinal direction (X-axis direction). The inductor wiring 10 extends in the longitudinal direction while winding in a smooth curve from the pad portion 10A (10B) to the other pad portion 10B (10A). The inductor component 2 thus has a so-called meander inductor structure.

The first magnetic layer 30 and the second magnetic layer 40 vertically disposed with the inductor wiring 10 interposed therebetween have uniaxial magnetic anisotropy axes that are oriented in the same axial direction. In the present embodiment, two anisotropy axes (easy axis and hard axis) of the first magnetic layer 30 and the second magnetic layer 40 are parallel in the longitudinal direction (X-axis direction) and the cross direction (Y-axis direction) when the inductor component 2 is viewed in plan (refer to FIG. 1). The expression “the first magnetic layer 30 and the second magnetic layer 40 have uniaxial magnetic anisotropy axes that are oriented in the same axial direction” refers to the fact that, in consideration of manufacturing variation, the angle formed by anisotropy axes of the first magnetic layer 30 and the second magnetic layer 40 falls within a range smaller than 10 degrees.

The anisotropy axes of the first magnetic layer 30 and the second magnetic layer 40 having uniaxial magnetic anisotropy axes that are oriented in the same axial direction are further described in detail. The easy-axis direction and the hard-axis direction of uniaxial magnetic anisotropy are measured by, for example, rotating a sample by 90 degrees, measuring the magnetic layer with a vibrating sample magnetometer (VSM), and obtaining a B-H curve. The B-H curve is also referred to as a magnetic hysteresis curve. An example of the measured B-H curve is illustrated in FIG. 3. The vertical axis in the graph in FIG. 3 indicates magnetic flux density B (measured in T), and the horizontal axis indicates magnetic field strength H (measured in A/m).

When the magnetic permeability is denoted by μ, the relationship B=μH is satisfied. More specifically, the inclination of the B-H curve in FIG. 3 indicates magnetic permeability μ. A B-H curve that rises steeply indicates the easy axis (easy axis of magnetization), and a B-H curve with gentle inclination indicates the hard axis (hard axis of magnetization). When the direction of a magnetic flux generated when current is passed through the inductor wiring 10 is parallel to the easy axis, inductor efficiency in achieving inductance can be improved. In contrast, when the direction of a magnetic flux generated when current is passed through the inductor wiring 10 is parallel to the hard axis, the inductor can improve direct current superimposition characteristics or reduce iron loss. A test sample for uniaxial magnetic anisotropy preferably has a circular, square, or flat shape to exclude the effect of shape anisotropy, but is measurable even when having other shapes.

In the present embodiment, the first magnetic layer 30 and the second magnetic layer 40 having uniaxial magnetic anisotropy may each have the hard axis oriented in the longitudinal direction (X-axis direction) and the easy axis oriented in the cross direction (Y-axis direction), or may each have the easy axis oriented in the longitudinal direction (X-axis direction) and the hard axis oriented in the cross direction (Y-axis direction).

In either case, both ends of the inductor wiring 10 are spaced apart in the direction (X-axis direction) of one of the anisotropy axes among the hard axis and the easy axis in the uniaxial magnetic anisotropy. The positions of both ends of the inductor wiring 10 in the direction (Y-axis direction) of the other one of the anisotropy axes may be the same or different. The inductor wiring 10 extends in a first anisotropy axis direction (X-axis direction) between the pad portions 10A and 10B at both ends while winding. Strikingly, the inductor wiring 10 extends throughout the entire area in a direction not orthogonal to the first anisotropy axis (X-axis direction). More specifically, the inductor wiring 10 extending between the pad portions 10A and 10B at both ends has a vector component constantly oriented in the first anisotropy axis direction (X-axis direction). The inductor wiring 10 never has only a vector component oriented in a second anisotropy axis direction (Y-axis direction) without having the vector component oriented in the first anisotropy axis direction (X-axis direction).

In other words, a wiring center line G (refer to FIG. 1) passing through the center of the inductor wiring 10 in the width direction extends throughout the entire area in a direction not orthogonal to the first anisotropy axis (X-axis direction). In other words, the wiring center line G and the first anisotropy axis (X-axis direction) cross each other at an angle less than 90 degrees.

The inductor wiring extending along the plane includes a spiral wiring. When a 360-degree rotation of the inductor wiring formed from a spiral wiring is defined as one turn, the inductor wiring in the present embodiment may be considered as a combination of connected parts of the inductor wiring 10, each having less than 0.5 turns.

When the inductor wiring 10 extends in the first anisotropy axis direction (X-axis direction), the inductor wiring 10 has a vector component oriented in the first anisotropy axis direction (X-axis direction), and thus a large part of the magnetic flux can be directed in the second anisotropy axis direction (Y-axis direction). If the inductor wiring 10 has an area extending perpendicularly to the first anisotropy axis direction (X-axis direction), the entire magnetic flux is oriented in the first anisotropy axis direction (X-axis direction) in that area, and the area is thus affected by the magnetic flux.

In the present embodiment, the inductor wiring 10 extends in the first anisotropy axis direction (X-axis direction), and a large part of the magnetic flux can thus be oriented in the second anisotropy axis direction (Y-axis direction). The effect resulting from orienting the magnetic flux in the second anisotropy axis direction (Y-axis direction) can thus be obtained. At the same time, the inductor wiring 10 extends throughout the entire area in a direction not orthogonal to the first anisotropy axis (X-axis), and thus, the effect of the first anisotropy axis (X-axis) can be reduced. The effect such as improvement of inductance acquisition efficiency, improvement of the direct current superimposition characteristics, or reduction of iron losses can thus be reliably obtained. In addition, the inductor component 2 is connected to an external circuit through the perpendicular wirings 20, and thus can be efficiently mounted.

When the first anisotropy axis oriented in the longitudinal direction (X-axis direction) is a hard axis, a large part of the magnetic flux passes along the easy axis (Y-axis direction), and thus the inductance acquisition efficiency can be improved. In contrast, when the first anisotropy axis oriented in the longitudinal direction (X-axis direction) is the easy axis, a large part of the magnetic flux passes along the hard axis (Y-axis direction), and thus the direct current superimposition characteristics can be improved or the iron losses can be reduced.

As described above, when the inductor component 2 has a substantially rectangular prism profile and the easy axis aligns with the longitudinal direction of a rectangular prism, the inductor component 2 further has effects described below. Considering the effect of shape magnetic anisotropy, when the easy axis aligns with the longitudinal direction, anisotropy axis control is facilitated. In addition, both ends of the inductor wiring 10 are disposed at a distance in the direction of the easy axis, and the pad portions 10A and 10B at both ends are disposed to overlap at least partially when viewed in the direction of the easy axis. The inductor wiring extends throughout the entire area in a direction not orthogonal to the easy axis. A large part of the magnetic flux passes along the hard axis, and thus direct current superimposition characteristics can be improved or iron losses can be reduced.

### <Method for Manufacturing Inductor Component>

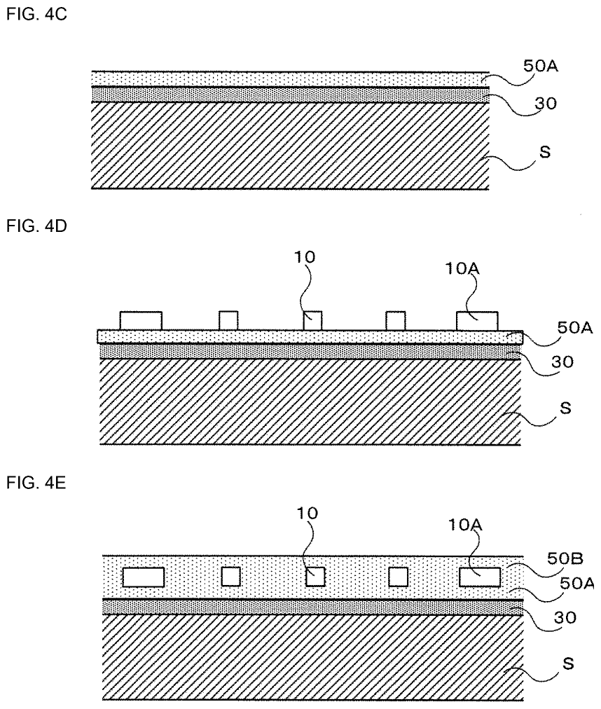

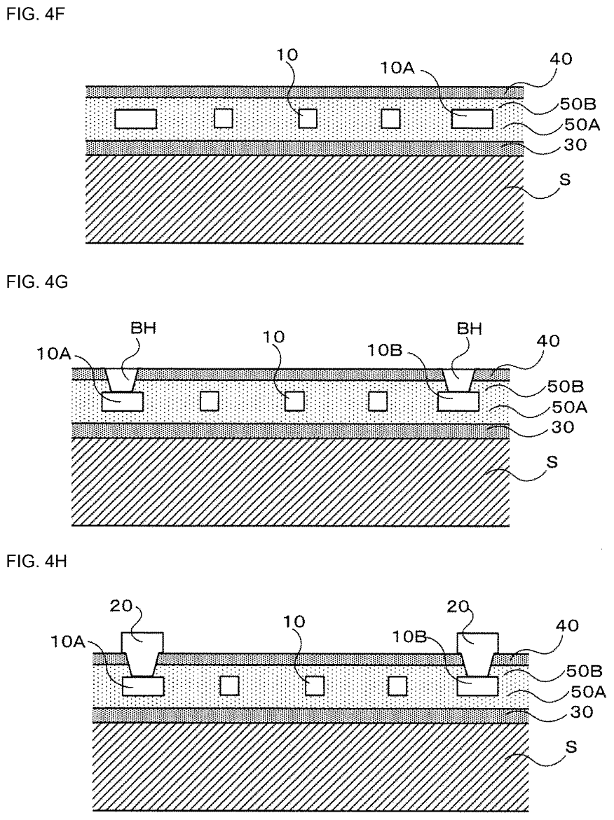

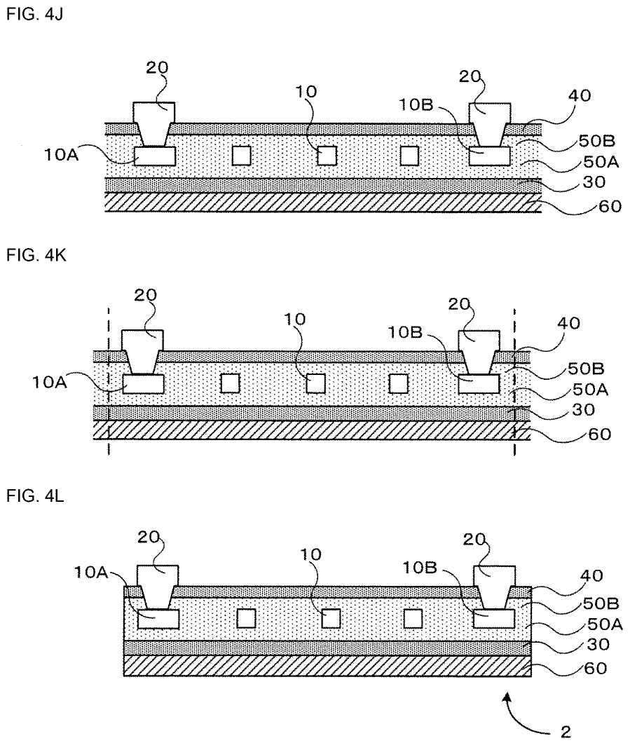

With reference to FIG. 4A to FIG. 4L, a method for manufacturing the inductor component 2 is now described. FIG. 4A is a schematic diagram describing a method for manufacturing the inductor component according to the first embodiment of the present disclosure, and is a side view describing a process 1 of preparing a substrate material. FIG. 4B is a side view describing a process 2, following the process 1, of laminating a first magnetic layer on the substrate material. FIG. 4C is a side view describing a process 3, following the process 2, of laminating a first insulating layer on the first magnetic layer. FIG. 4D is a side view describing a process 4, following the process 3, of forming an inductor wiring on the first insulating layer. FIG. 4E is a side view describing a process 5, following the process 4, of laminating a second insulating layer on the first insulating layer on which the inductor wiring is disposed. FIG. 4F is a side view describing a process 6, following the process 5, of laminating a second magnetic layer on the second insulating layer. FIG. 4G is a side view describing a process 7, following the process 6, of forming via holes on the surface of the second magnetic layer. FIG. 4H is a side view describing a process 8, following the process 7, of forming perpendicular wirings in the via holes. FIG. 4J is a side view describing a process 9, following the process 8, of grinding the substrate material into a substrate with a predetermined thickness. FIG. 4K is a side view describing a process 10, following the process 9, of dicing using cutting means. FIG. 4L is a side view of an inductor component formed by dicing in the process 10.

### Process 1

First, as illustrated in FIG. 4A, the process 1 of preparing a substrate material S is performed. The substrate material S is formed from high-resistivity silicon as described above. The thickness of the substrate material S illustrated is greater than the final thickness of the finished substrate 60. In the process, multiple inductor components are formed in one substrate material S, and the substrate material S is then diced to obtain separate inductor components 2.

### Process 2

Subsequently, as illustrated in FIG. 4B, the process 2 of laminating the first magnetic layer 30 on the substrate material S is performed. As illustrated in an enlarged diagram on the right side in FIG. 4B, the first magnetic layer 30 is formed from a laminate body including inorganic insulating layers 30A and inorganic magnetic layers 30B. For example, the inorganic insulating layers 30A and the inorganic magnetic layers 30B are sequentially laminated by sputtering. The inorganic insulating layers 30A may thus be referred to as sputtering insulating layers 30A, and the inorganic magnetic layers 30B may be referred to as sputtering magnetic layers 30B.

An example of a method for imparting uniaxial magnetic anisotropy to the first magnetic layer 30 is described below. When the inorganic magnetic layers 30B are manufactured in a magnetic field by sputtering, atoms in the inorganic magnetic layers 30B are arranged at desired locations, and the easy-axis direction can be oriented in the magnetic-field application direction. When the magnetic-field application direction is oriented in the longitudinal direction of the inductor component 2, the easy axis aligns with the longitudinal direction. When the magnetic-field application direction is oriented in the cross direction of the inductor component 2, the hard axis aligns with the longitudinal direction.

The inorganic insulating layers 30A can be formed from an inorganic insulating material such as SiO₂ or TaO. The inorganic magnetic layers 30B can be formed from CZT (Co—Zr—Ta), a FeNi alloy, or a composite containing a magnetic material and an inorganic material. The inter-layer thickness between the inorganic magnetic layers 30B is preferably smaller than each inorganic magnetic layer 30B. The inorganic insulating layers 30A have a function of insulating the inorganic magnetic layers 30B from each other, or protecting the inorganic magnetic layers 30B from stress caused in processing. The inorganic insulating layers 30A that are thinner can thus increase the proportion of the magnetic layers relative to the entire laminate body. The lamination structure in which each inorganic insulating layer 30A formed from, for example, TaO or SiO₂, is disposed between the inorganic insulating layers 30B enables insulation between the inorganic magnetic layers 30B and reduction of eddy currents in the inorganic magnetic layers 30B. The inductor component 2 thus has a high Q factor at a high frequency.

When, for example, the thickness of CZT (Co—Zr—Ta) or a FeNi alloy in the inorganic magnetic layers 30B is increased, eddy current occurs in the magnetic layers. The thickness is thus preferably smaller. More specifically, the thickness is preferably smaller than the skin depth derived from the circuit operation frequency, for example, the switching frequency of a DCDC converter. In contrast, the inductor is a current-carrying element. The inductor wiring 10 is thus preferably thicker to allow a larger current to flow.

In consideration of these points, in the inductor component 2 according to the present embodiment, a thickness of the first magnetic layer 30 is smaller than a thickness of the inductor wiring 10 in the direction orthogonal to the plane. The inorganic magnetic layers 30B that are thin can reduce occurrence of eddy currents in the inorganic magnetic layers 30B, and the inductor wiring 10 that is thick can achieve the inductor component 2 with low direct-current resistance and high inductor acquisition efficiency.

In addition, in the present embodiment, the inorganic insulating layers 30A form the surface of the first magnetic layer 30 formed from a laminate body including the inorganic insulating layers 30A and the inorganic magnetic layers 30B. In this manner, the inorganic insulating layers 30A form the surface of the first magnetic layer 30, and thus can reliably insulate the first magnetic layer 30 from surrounding components such as wirings. The same applies to the second magnetic layer 40 described later.

### Process 3

Subsequently, as illustrated in FIG. 4C, the process 3 of laminating the first insulating layer 50A on the first magnetic layer 30 formed in the process 2 is performed. More specifically, polyimide formed from an organic resin is applied to the first magnetic layer 30, and cured to form the first insulating layer 50A.

### Process 4

Subsequently, as illustrated in FIG. 4D, the process 4 of forming the inductor wiring 10 by electric-field electroplating on the first insulating layer 50A formed in the process 3 is performed. More specifically, a seed layer formed from Ti/Cu is formed on the first insulating layer 50A by sputtering. A dry film resist (DFR) is then laminated on the seed layer, and the seed layer with a shape corresponding to the inductor wiring is exposed by photolithography. Then, power is fed from the seed layer, and a plated portion is deposited by electric-field electroplating on the exposed seed layer to form the inductor wiring. The dry film resist (DFR) is then detached, and the seed layer is etched to obtain an insulated independent inductor wiring. The inductor wiring 10 with a meandering shape is thus formed.

### Process 5

Subsequently, as illustrated in FIG. 4E, the process 5 of laminating the second insulating layer 50B on the first insulating layer 50A on which the inductor wiring 10 formed in the process 4 is disposed is performed. More specifically, as in the case of the first insulating layer 50A, polyimide formed from an organic resin is applied and cured to form the second insulating layer 50B. The second insulating layer 50B is thus formed to cover the side surfaces and the upper surface of the inductor wiring 10. In this manner, the first insulating layer 50A and the second insulating layer 50B surrounding the inductor wiring 10 are formed.

### Process 6

Subsequently, as illustrated in FIG. 4F, the process 6 of laminating the second magnetic layer 40 on the second insulating layer 50B formed in the process 5 is performed. The second magnetic layer 40 can also be laminated in the same process as the process performed for the first magnetic layer 30. As in the case of the first magnetic layer 30, when the second magnetic layer 40 is manufactured in a magnetic field by sputtering, the easy-axis direction of the inorganic magnetic layer can be oriented in the magnetic-field application direction. When the axis directions are oriented in the same magnetic-field application direction while the first magnetic layer 30 and the second magnetic layer 40 are formed, the first magnetic layer 30 and the second magnetic layer 40 are allowed to have uniaxial magnetic anisotropy axes that are oriented in the same axial direction.

### Process 7

Subsequently, as illustrated in FIG. 4G, the process 7 of forming via holes on the surface of the second magnetic layer 40 formed in the process 6 is performed. More specifically, the surface of the second magnetic layer is irradiated with laser beams to remove parts of the second magnetic layer 40 and the second insulating layer 50B, and to form via holes BH extending to the pad portions 10A and 10B of the inductor wiring 10. The via holes BH thus formed are tapered as they extend deeper from the surface of the second magnetic layer.

### Process 8

Subsequently, as illustrated in FIG. 4H, the process 8 of forming the perpendicular wirings 20 in the via holes BH formed in the process 7 is performed. While the via holes BH are formed with irradiation of laser beams, resin residues referred to as smear are left. First, desmear processing of removing smear (resin residues) resulting from laser processing is performed. After the via holes BH are cleaned by desmear processing, the perpendicular wirings 20 are formed in the via holes BH. The perpendicular wirings 20 can be formed in the via holes BH by electroplating in the same manner as a method for forming the inductor wiring 10. When formed by electroplating, the low-resistance perpendicular wirings 20 can be obtained at low cost. The perpendicular wirings 20 may be formed by plating other than electroplating, sputtering, deposition, or an application method.

### Process 9

Subsequently, as illustrated in FIG. 4J, the process 9 of grinding the substrate material S to form the substrate 60 with a predetermined thickness is performed following the process 8. However, the process 9 may be excluded when the substrate material S has the predetermined thickness in advance. For example, when a temporarily bonded layer is disposed on the substrate material S, and the first magnetic layer 30 is manufactured on the temporarily bonded layer, the substrate material S can be removed from the first magnetic layer 30 after the processes 1 to 8 are performed. The inductor component 6 not including the substrate illustrated in FIG. 7 can thus also be obtained.

### Process 10

Subsequently, as illustrated in FIG. 4K, the process 10 of dicing using cutting means is performed following the process 9 (or in some cases, process 8). FIG. 4L illustrates the inductor component 2 obtained by dicing in the process 10.

### MODIFICATION EXAMPLES OF FIRST EMBODIMENT

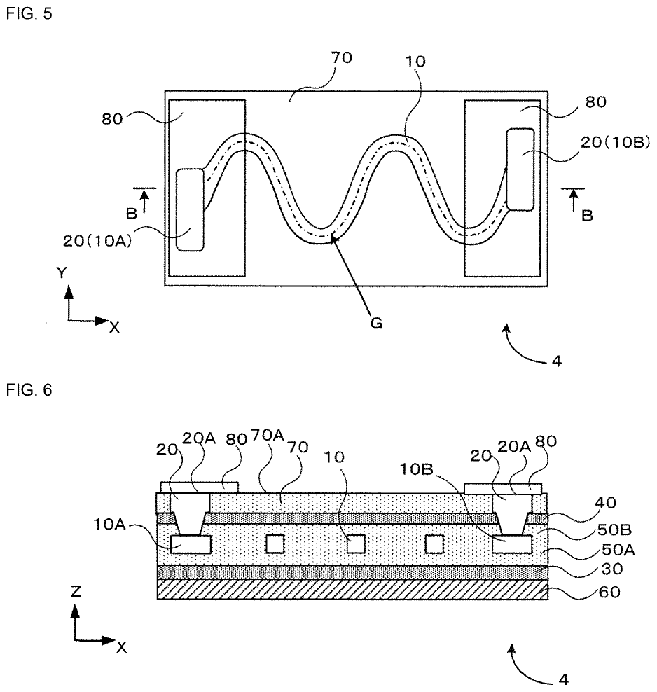

With reference to FIG. 5 to FIG. 8, modification examples of the first embodiment are described.

### Modification Example 1

First, with reference to FIG. 5 and FIG. 6, an inductor component according to a modification example 1 of the first embodiment is described. FIG. 5 is a schematic plan view of an inductor component according to a modification example 1 of the first embodiment of the present disclosure. FIG. 6 is a side cross-sectional view taken along line B-B in FIG. 5. In FIG. 5, the perpendicular wirings and the inductor wiring are drawn with solid lines in perspective.

An inductor component 4 according to the modification example 1 differs from the inductor component 2 according to the first embodiment in that a third insulating layer 70 formed from an inorganic insulating layer is further disposed on the surface of the laminated second magnetic layer 40. The side surfaces of each perpendicular wiring 20 are covered with the third insulating layer 70. The third insulating layer 70 may be formed from the same material as the first and second insulating layers 50A and 50B or a different material.

The side surfaces of each perpendicular wiring 20 facing in a direction parallel to the plane are thus covered with the third insulating layer 70, and current leakage toward, for example, the second magnetic layer 40 can thus be reduced.

A surface 70A of the third insulating layer 70 is on the same level as the end surfaces 20A of the perpendicular wirings 20, and external terminals 80 are disposed to be in contact with the surface 70A of the third insulating layer 70 and the end surfaces 20A of the perpendicular wirings 20. Like the perpendicular wirings 20, the external terminals 80 may be formed by, for example, electroplating, sputtering, or electroless plating.

The external terminals 80 extending over a plane parallel to the plane overlap the second magnetic layer 40 when the plane is viewed in the perpendicular direction. More specifically, in a plan view, the external terminals 80 extend further outward beyond the second magnetic layer 40. As described above, the inductor component 4 includes the external terminals 80 connected to the perpendicular wirings 20 and extending over a plane parallel to the plane, and the external terminals 80 overlap the second magnetic layer 40 when the plane is viewed in the perpendicular direction. The external terminals 80 can thus be increased in size, reduce electric resistance, and improve adhesion strength.

### Modification Example 2

Subsequently, an inductor component according to a modification example 2 of the first embodiment is described with reference to FIG. 7. FIG. 7 is a schematic side cross-sectional view of an inductor component according to modification example 2 of the first embodiment of the present disclosure.

The inductor component 6 according to the modification example 2 does not include the substrate 60. The inductor component 6 not including the substrate 60 can achieve thickness reduction. As in the case of the modification example 1, a first perpendicular wiring 20 (perpendicular wiring on the left in the drawing) connected to the pad portion 10A of the inductor wiring 10 is covered with the third insulating layer 70, and the external terminal 80 is disposed on the end surface 20A of the perpendicular wiring 20.

In contrast, a second perpendicular wiring 22 (perpendicular wiring on the right in the drawing) is connected to the surface of the pad portion 10B of the inductor wiring 10 closer to the first magnetic layer 30 (lower surface in the drawing). The second perpendicular wiring 22 extends through the first magnetic layer 30, and protrudes outward. In the modification example 2, the inductor component 6 with reduced thickness is thus achieved, and can be connected to an external circuit from the top and the bottom, and improves freedom of installation locations.

### Modification Example 3

Subsequently, with reference to FIG. 8, an inductor component according to a modification example 3 of the first embodiment is described. FIG. 8 is a schematic side cross-sectional view of an inductor component according to a modification example 3 of the first embodiment of the present disclosure.

The inductor component 6 according to the modification example 3 includes a substrate 60. As in the cases of the modification examples 1 and 2, a first perpendicular wiring 20 (perpendicular wiring on the left in the drawing) connected to the pad portion 10A of the inductor wiring 10 is covered with the third insulating layer 70, and the external terminal 80 is formed on the end surface 20A of the perpendicular wiring 20.

In contrast, as in the case of the modification example 2, a second perpendicular wiring 22 (perpendicular wiring on the right in the drawing) is connected to the surface of the pad portion 10B of the inductor wiring 10 closer to the first magnetic layer 30 (lower surface in the drawing). In the example 3, the second perpendicular wiring 22 extends through the first magnetic layer 30 and the substrate 60. An end surface 22A of the second perpendicular wiring 22 is disposed on the same level as the surface of the substrate 60, and exposed to the outside.

As described above, in the example 3, the perpendicular wirings 20 extend through the substrate 60 formed from an inorganic substrate. This structure enables connection to an external circuit from the top and the bottom, and thus improves freedom of installation locations, and the presence of the inorganic substrate ensures substrate strength.

As in the modification example 2 or 3, the perpendicular wirings 20 and 22 extend on both sides of the inductor wiring 10, and enable connection to an external circuit from the top and the bottom, and thus improve freedom of installation locations.

### (Inductor Component According to Second Embodiment of Present Disclosure)

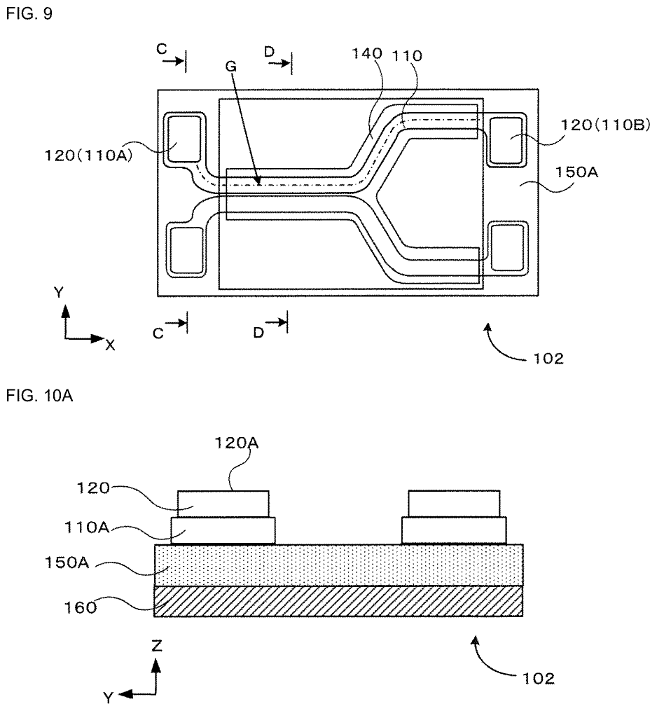

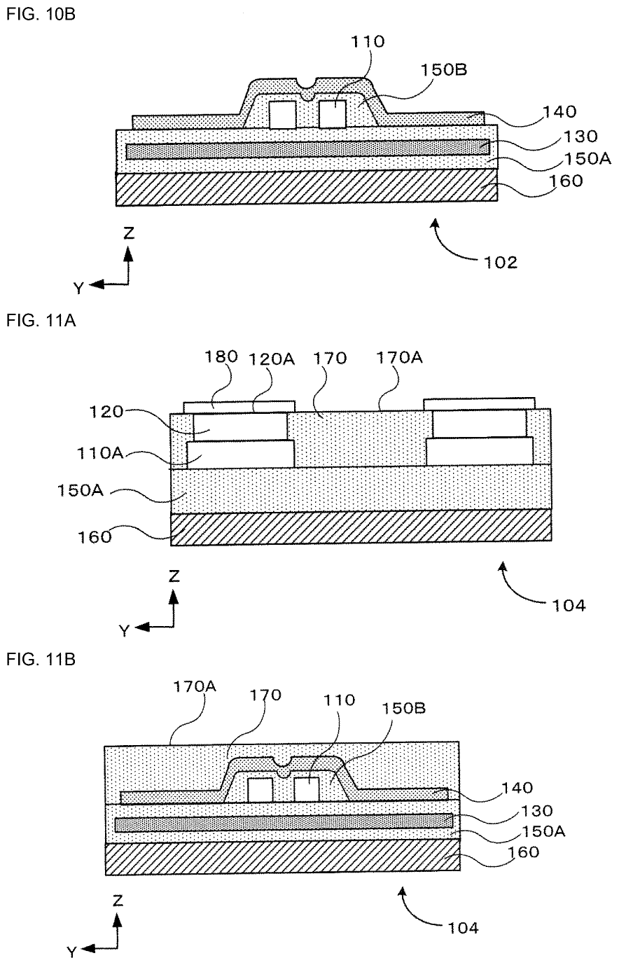

With reference to FIG. 9, FIG. 10A, and FIG. 10B, an inductor component according to a second embodiment of the present disclosure is described. FIG. 9 is a schematic plan view of an inductor component according to a second embodiment of the present disclosure. FIG. 10A is a side cross-sectional view taken along line C-C in FIG. 9. FIG. 10B is a side cross-sectional view taken along line D-D in FIG. 9. Also in FIG. 9, the inductor wirings are drawn with solid lines in perspective.

An inductor component 102 according to the second embodiment of the present disclosure differs from the inductor component according to the first embodiment in the way in which the inductor wirings extend, and in that two inductor wirings 110 are disposed along a plane. In each of the inductor wirings 110, two areas extending parallel to the first anisotropy axis direction (X-axis direction) among the hard axis and the easy axis in the uniaxial magnetic anisotropy are connected in an area extending in a direction crossing the anisotropy axis direction (X-axis direction). As in the case of the first embodiment, the area of each inductor wiring 110 extending in the direction crossing the first anisotropy axis direction (X-axis direction) also extends in a direction not orthogonal to the first anisotropy axis (X-axis).

More specifically, also in the inductor component 102 according to the second embodiment, both ends of each inductor wiring 110 are spaced apart in the first anisotropy axis direction (X-axis direction) among the hard axis and the easy axis in the uniaxial magnetic anisotropy, and the inductor wiring 110 extends throughout the entire area in a direction not orthogonal to the first anisotropy axis (X-axis). Both ends of each inductor wiring 10 may be located at the same position or different positions in the second anisotropy axis direction (Y-axis direction).

The second embodiment differs from the first embodiment in the way in which the inductor wirings 110 extend, but has substantially the same lamination structure as that in the first embodiment. As illustrated in FIG. 10B, a first insulating layer 150A is laminated on a substrate 160, and a first magnetic layer 130 is laminated to be placed in the first insulating layer 150A. The inductor wirings 110 are disposed thereon, a second insulating layer 150B is further laminated to cover the inductor wirings 110, and a second magnetic layer 140 is further laminated to cover the second insulating layer 150B. In the present embodiment, no insulating layer is disposed over the second magnetic layer 140.

For example, the inductor wiring 110 may have cross-sectional dimensions of 40 μm×20 μm, the substrate 160 may have a thickness of 5 μm, the first magnetic layer 130 and the second magnetic layer 140 may have a thickness of 5 to 6 μm. The first insulating layer 150A has a thickness corresponding to the value obtained by adding about 2 to 10 μm to the thickness of the first magnetic layer 130. The second insulating layer 150B has a thickness corresponding to the value obtained by adding about 2 to 10 μm to the thickness of the inductor wirings 10. For example, the dimension by which perpendicular wirings 120 protrude from the surface of the second magnetic layer 140 may be 5 μm, and the inductor component 102 having a substantially rectangular prism profile may have dimensions (L×W×T) of 1.0 mm×0.5 mm1×0.5 mm. However, these dimensions are mere examples, and are not limited to these.

The materials of the components are the same as those in the case of the first embodiment, and the inductor component 102 according to the second embodiment can be manufactured with the same method as that for the first embodiment.

In the present embodiment, in each inductor component 102, two inductor wirings 110 are disposed along the plane, but the number of inductor wirings 110 is not limited to this example. Three or more inductor wirings 110 may be disposed along the plane. In that case, for example, multiple inductor components 102 may be symmetrically arranged with respect to the center line extending in the longitudinal direction (X-axis direction) of the inductor components 102 having a rectangular plane.

In the present embodiment, the multiple inductor wirings 110 are arranged along the plane, and thus an inductor array element can be formed. This structure can save installation gaps, and thus can save space.

FIG. 13 is a schematic plan view of an example of an inductor component including multiple inductor wirings disposed along a plane. As illustrated in FIG. 13, when the multiple inductor wirings 110 are disposed along the plane, the first magnetic layer 130 and the second magnetic layer 140 have a nearly square shape when viewed in plan. The effect of shape magnetic anisotropy can thus be reduced, and materials can be selected from a wider range.

As an example of a nearly square shape, the ratio between the dimension P in the first anisotropy axis direction (X-axis direction) and the dimension Q in the second anisotropy axis direction (Y-axis direction), more specifically, Q/P is preferably within the range greater than or equal to 0.5 and less than or equal to 1 (i.e., from 0.5 to 1), more preferably, within the range greater than or equal to 0.7 and less than or equal to 1 (i.e., from 0.7 to 1). In consideration of the case where the first magnetic layer 130 and the second magnetic layer 140 do not have the same shape, preferably, multiple inductor wirings 110 extending in the same plane parallel to the plane are included, at least one of the first magnetic layer 130 or the second magnetic layer 140 overlaps the multiple inductor wirings 110 when the plane along which the inductor wirings 110 extend is viewed in the perpendicular direction, and the ratio of the dimension of the outer periphery in the first anisotropy axis direction (X-axis direction) and the dimension of the outer periphery in the second anisotropy axis direction (Y-axis direction) is within the range greater than or equal to 0.5 and less than or equal to 1 (i.e., from 0.5 to 1), more preferably, within the range greater than or equal to 0.7 and less than or equal to 1 (i.e., from 0.7 to 1).

As illustrated in FIG. 9, the multiple inductor wirings 110 disposed along the plane include an area where the inductor wirings 110 are arranged parallel to each other, and an area where the inductor wirings 110 are not arranged parallel to each other. The area where the inductor wirings 110 are not arranged parallel to each other forms an area where the inductor wirings 110 are arranged adjacent and parallel to each other and an area where the inductor wirings 110 are arranged at a distance and parallel to each other. This arrangement can increase a coupling coefficient in the area where the inductor wirings 110 are adjacent to each other, and lower the coupling coefficient in the area where the inductor wirings 110 are spaced apart from each other. Connecting the areas where the inductor wirings 110 are arranged parallel with the area where the inductor wirings 110 are not arranged parallel enables various control on the coupling coefficient of the inductor.

As illustrated in FIG. 10B, in the area where the inductor wirings 110 are adjacent to each other, the second magnetic layer 140 has an uneven shape that covers the inductor wirings 110 from three directions. When viewed in cross section taken in a direction orthogonal to the direction in which the inductor wirings 110 extend, the second magnetic layer 140 has an uneven shape that covers the inductor wirings 110 from two directions parallel to the plane and one direction perpendicular to the plane. The second magnetic layer 140 can thus cover the entire peripheries of the inductor wirings 110 together with the first magnetic layer 130, and thus inductor efficiency in achieving inductance can be improved.

As is clear from FIG. 9 and FIG. 10B, when the plane is viewed in the perpendicular direction, the second magnetic layer 140 is positioned on the inner side from the outer periphery of the inductor component 102. During dicing, the magnetic layers are thus not damaged from cutting. For example, when the magnetic layers are extended by mechanical stress during cutting, leakage occurs between the laminated magnetic layers, and an iron loss increases. However, the present embodiment can prevent such inconvenience.

In the present embodiment, as illustrated in FIG. 10A, the first magnetic layer 130 and the second magnetic layer 140 are not disposed in the areas at both ends of the inductor wirings 110 including pad portions 110A and 110B. The perpendicular wirings 120 connected to the pad portions 110A and 110B thus do not extend through the magnetic layers. In the present embodiment, the magnetic layers are disposed in the area excluding both ends of the inductor wirings 110.

### MODIFICATION EXAMPLES OF SECOND EMBODIMENT

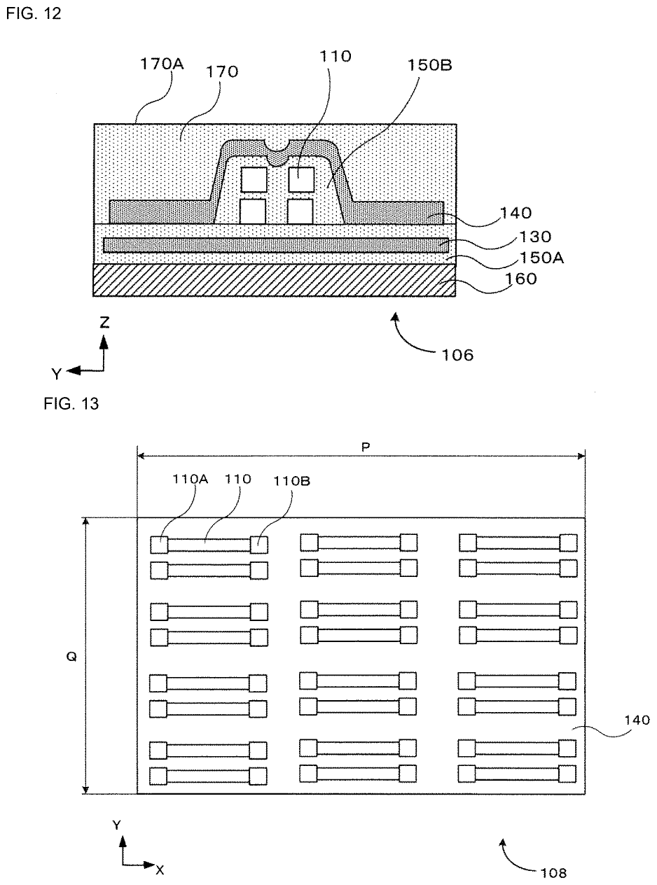

Subsequently, with reference to FIG. 11A, FIG. 11B, and FIG. 12, modification examples of the second embodiment are described.

### Modification Example 1

First, with reference to FIG. 11A and FIG. 11B, an inductor component according to a modification example 1 of the second embodiment is described. FIG. 11A is a schematic diagram of an inductor component according to a modification example 1 of the second embodiment of the present disclosure, and is a side cross-sectional view taken along the same plane as that in FIG. 10A. FIG. 11B is a schematic diagram of an inductor component according to the modification example 1 of the second embodiment of the present disclosure, and is a side cross-sectional view taken along the same plane as that in FIG. 10B.

An inductor component 104 according to the modification example 1 differs from the inductor component 102 according to the second embodiment in that a third insulating layer 170 formed from an inorganic insulating layer is further disposed on the surface of the laminated second magnetic layer 140. As illustrated in FIG. 11A, the side surfaces of the perpendicular wirings 120 are thus covered with the third insulating layer 170. As illustrated in FIG. 11B, the second magnetic layer 140 with an uneven shape is also covered with the third insulating layer 170.

A surface 170A of the third insulating layer 170 is located on the same level as end surfaces 120A of the perpendicular wirings 120, and external terminals 180 are disposed to be in contact with the surface 170A of the third insulating layer 170 and the end surfaces 120A of the perpendicular wirings 120. As in the case described above, the external terminals 180 can be formed by, for example, electroplating, sputtering, or electroless plating.

As described above, in the modification example 1 of the second embodiment, the first magnetic layer 130 and the second magnetic layer 140 are covered with the first insulating layer 150A, the second insulating layer 150B, and the third insulating layer 170, and thus can be protected from the environmental conditions (such as humidity).

In addition, the surface of the third insulating layer 170 covering the second magnetic layer 140 and serving as the outermost surface of the inductor component 104 is flat as compared to the second magnetic layer 140 with an uneven shape, and thus has improved coplanarity in installation. Coplanarity refers to the properties or the state of multiple points lying in the same plane. Coplanarity may also be referred to as “surface uniformity” or “terminal flatness”.

### Modification Example 2

With reference to FIG. 12, an inductor component according to a modification example 2 of the second embodiment is now described. FIG. 12 is a schematic diagram of an inductor component according to a modification example 2 of the second embodiment of the present disclosure, and is a side cross-sectional view taken along the same plane as that in FIG. 10B.

An inductor component 106 according to the modification example 2 includes inductor wirings 110 extending along the plane and formed from multiple layers. The example illustrated in FIG. 12 includes two layers each including two inductor wirings 110 disposed along the plane. More specifically, in a cross-sectional view, the inductor wirings 110 are arranged in a 2×2 matrix. The space between the layers of the inductor wirings 110 is filled with an insulating material (second insulating layer 150B). However, the structure is not limited to this example, and the inductor component 106 in a matrix in which an appropriate number of layers of an appropriate number of inductor wirings 110 are arranged along the plane may be employed.

The inductor wirings 110 extending along the plane are defined as first inductor wirings. In a structure further including second inductor wirings extending along the plane parallel to the plane, and in which the space between the first inductor wirings and the second inductor wirings is filled with an insulating resin, the freedom of the inductor wirings 110 is improved. In addition, when the space between the inductor wirings 110 is filled with the insulating resin, current leakage can be reduced, and the inductor wirings 110 can be located closer. The inductor component 106 can thus be reduced in thickness.

### Inductor Component According to Third Embodiment of Present Disclosure

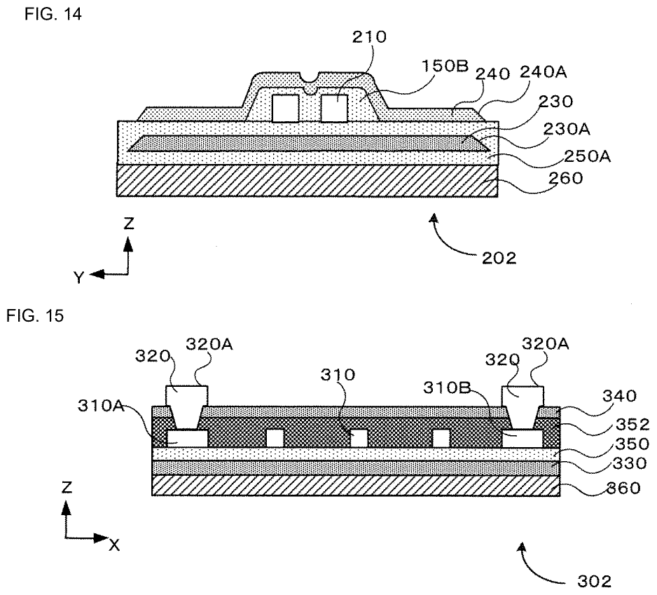

Subsequently, with reference to FIG. 14, an inductor component according to a third embodiment of the present disclosure is described. FIG. 14 is a schematic diagram of an inductor component according to a third embodiment of the present disclosure, and is a side cross-sectional view taken along the same plane as that in FIG. 10B.

An inductor component 202 according to the third embodiment has the same shape as the inductor component 102 according to the second embodiment when viewed in plan. More specifically, the inductor component 202 includes an area where two inductor wirings 210 are arranged parallel to each other, and an area where the two inductor wirings 210 are not arranged parallel to each other. FIG. 14 illustrates a cross section of an area where the two inductor wirings 210 are arranged adjacent and parallel to each other.

The inductor component 202 according to the third embodiment differs from the inductor component 102 according to the second embodiment in which the end portions are perpendicularly disposed, in that an end portion 230A of a first magnetic layer 230 and an end portion 240A of a second magnetic layer 240 have inclined portions.

When the end portions of the magnetic layers are perpendicularly disposed, the magnetic layers are to be processed to have holes or the wiring design is to be changed to change the electric characteristics of the inductor. However, in the inductor component 202 according to the third embodiment, when viewed in cross section taken in a direction orthogonal to the direction in which the inductor wirings 110 extend, the end portions 230A and 240A of the magnetic layers 230 and 240 include the inclined portions inclined with respect to a direction perpendicular to the plane. The characteristics of the inductor can thus be adjusted without performing processing to form holes or changing the wiring design.

### (Inductor Component According to Fourth Embodiment of Present Disclosure)

With reference to FIG. 15 now, an inductor component according to a fourth embodiment of the present disclosure is described. FIG. 15 is a schematic diagram of an inductor component according to a fourth embodiment of the present disclosure, and is a side cross-sectional view taken along the same plane as that in FIG. 2.

An inductor component 302 according to the fourth embodiment has the same shape as the inductor component 2 according to the first embodiment when viewed in plan. More specifically, the inductor component 302 has a so-called meander inductor structure that extends while winding in a smooth curve. However, the structure of the inductor component 302 is not limited to this, and the inductor component 302 may have the same structure as the inductor component 102 according to the second embodiment, including an area in which two inductor wirings are arranged parallel, and an area in which two inductor wirings are not arranged parallel.

In the inductor component 2 according to the first embodiment, the second insulating layer 50B is disposed to surround the inductor wiring 10 disposed on the first insulating layer 50A. The inductor component 302 according to the third embodiment differs from the inductor component 2 in that an organic resin, an inorganic filler, and a composite portion 352, instead of an insulating layer, are disposed to surround an inductor wiring 30 disposed on the insulating layer 350.

The inductor component 302 according to the fourth embodiment includes the magnetic composite portion 352, containing an organic resin and an inorganic filler, between a first magnetic layer 330 and a second magnetic layer 340, which are inorganic magnetic layers. The composite portion 352 is a composite body containing an organic resin and a magnetic filler. For example, an organic resin may be epoxy, acryl, phenol, or a combination of any of these, and a magnetic filler may be ferrite, an iron-based material, or an iron-based alloy. Alternatively, the organic resin may contain an insulating filler such as a silica filler to adjust insulating properties or a coefficient of linear expansion. In the present embodiment, an epoxy resin is used as an organic resin, and FeSiCr is used as an inorganic filler.

By containing Si and Cr, the magnetic composite portion 352 has strained crystals, and magnetic permeability of the magnetic layers can be increased. Particularly, by containing Si, the magnetic composite portion 352 has strained crystals, and thus the magnetic layers have higher magnetic permeability than those in the structure simply containing Fe. Cr is easily oxidized. When Cr is located on the surface, Cr on the surface is thus oxidized, and can prevent oxidation of the inside of the magnetic composite portion 352. In this manner, when the magnetic composite portion 352 contains Si and Cr, the balance between magnetic saturation and magnetic permeability of the magnetic layers can be achieved, and high magnetic permeability of the magnetic layers can be maintained. The reliability of the inductor component 302 can thus be improved.

A narrower distance between the first magnetic layer 330 and the second magnetic layer 340 further increases magnetic permeability of the magnetic layers, but the magnetic layers may increase eddy currents and lower the Q factor. The Q factor is also referred to as a quality factor, and indicates “the sharpness” of a signal at the resonance frequency. The ratio of the resistance (R) of an inductor wiring to the inductance (L) at frequency f(R/2πf·L) is referred to as a loss factor, and its reciprocal corresponds to the Q factor. As the inductor has a higher Q factor, the inductor has a smaller loss. The inductor thus has more efficient characteristics as a high-frequency inductor.

The inductor component 302 according to the present embodiment includes the magnetic composite portion 352, containing an organic resin and an inorganic filler, between the first magnetic layer 330 and the second magnetic layer 340. The inductor component 2 can thus reduce eddy current regardless of whether the distance between the first magnetic layer 330 and the second magnetic layer 340 is reduced, and thus can be reduced in thickness.

In addition, as including the magnetic composite portion 352, the inductor component 302 can reduce eddy current regardless of whether the distance between the first magnetic layer 330 and the second magnetic layer 340 is reduced. The inductor component 302 can thus acquire a high Q factor. The thin inductor components 302 capable of reducing eddy current and acquiring a high Q factor while reducing a distance between two magnetic layers can thus be provided.

### (Summarization)

As described above, each one of the inductor components 2 to 8, 102 to 106, 302, and 402 according to the above embodiments includes at least one inductor wiring 10, 110, 210, or 310 extending along a plane; pad portions 10A and 10B, 110A and 110B, 210A and 210B, or 310A and 310B located at two ends of the inductor wiring; perpendicular wirings 20, 120, 220, or 320 extending perpendicularly to the plane from the pad portions 10A and 10B, 110A and 110B, 210A and 210B, or 310A and 310B; and a first magnetic layer 30, 130, 230, or 330 and a second magnetic layer 40, 140, 240, or 340 that hold the inductor wiring 10, 110, 210, or 310 therebetween, wherein the first magnetic layer 30, 130, 230, or 330 and the second magnetic layer 40, 140, 240, or 340 have uniaxial magnetic anisotropy axes oriented in the same axial direction, and wherein the inductor wiring 10, 110, 210, or 310 extends throughout an entire area in a direction not orthogonal to a first anisotropy axis (X-axis).

Since the inductor wiring 10, 110, 210, or 310 extends throughout an entire area in a direction not orthogonal to a first anisotropy axis (X-axis), the inductor component can reduce the effect of the first anisotropy axis. When the hard axis aligns with the longitudinal direction, the inductance acquisition efficiency can thus be improved. In contrast, when the easy axis aligns with the longitudinal direction, the direct current superimposition characteristics can be improved. In addition, the inductor component 2, 102, 202, or 302 is connected to an external circuit through the perpendicular wirings 20, 120, 220, or 320, and thus can be efficiently mounted.

The present disclosure includes the aspects described below.

<1> An inductor component comprising an inductor wiring extending along a plane; pad portions located at two ends of the inductor wiring; perpendicular wirings extending perpendicularly to the plane from the pad portions; and a first magnetic layer and a second magnetic layer that hold the inductor wiring therebetween. The first magnetic layer and the second magnetic layer have uniaxial magnetic anisotropy axes oriented in the same axial direction. The inductor wiring extends throughout an entire area in a direction not orthogonal to a first one of the anisotropy axes.

<2> The inductor component according to <1>, wherein the first one of the anisotropy axes is an easy axis.

<3> The inductor component according to <2>, wherein the inductor component has a shape of a substantially rectangular prism, and the easy axis aligns with a longitudinal direction of the rectangular prism. The two ends of the inductor wiring are spaced apart in a direction of the easy axis, and the pad portions at the two ends overlap at least partially when viewed in the direction of the easy axis.

<4> The inductor component according to any one of <1> to <3>, wherein the first magnetic layer and the second magnetic layer are each formed from a laminate body including inorganic insulating layers and inorganic magnetic layers, and a thickness of the first magnetic layer and the second magnetic layer in a direction orthogonal to the plane is smaller than a thickness of the inductor wiring.

<5> The inductor component according to <4>, wherein the inorganic insulating layer is disposed at a surface of each of the first magnetic layer and the second magnetic layer formed from the laminate body.

<6> The inductor component according to any one of <1> to <5>, wherein a plurality of conductive layers are disposed at end surfaces of the perpendicular wirings that are in contact with the pad portions and at opposite end surfaces.

<7> The inductor component according to any one of <1> to <6>, wherein the perpendicular wirings extend through at least one of the first magnetic layer or the second magnetic layer.

<8> The inductor component according to any one of <1> to <7>, wherein side surfaces of the perpendicular wirings facing in a direction parallel to the plane are covered with an insulating layer.

<9> The inductor component according to any one of <1> to <8>, further comprising an external terminal connected to any of the perpendicular wirings and extending along a plane parallel to the plane. The external terminal overlaps at least one of the first magnetic layer or the second magnetic layer when the plane is viewed in a perpendicular direction.

<10> The inductor component according to any one of <1> to <9>, wherein the first magnetic layer is disposed on an inorganic substrate, and the perpendicular wirings extend through the inorganic substrate.

<11> The inductor component according to any one of <1> to <10>, wherein the perpendicular wirings extend on two sides of the inductor wiring.

<12> The inductor component according to any one of <1> to <11>, comprising a plurality of inductor wirings each corresponding to the inductor wiring, and extending along the same plane.

<13> The inductor component according to any one of <1> to <12>, wherein the inductor component includes an area in which the plurality of inductor wirings disposed along a plane are arranged parallel and an area in which the plurality of inductor wirings are not arranged parallel.

<14> The inductor component according to any one of <1> to <13>, wherein, when viewed in cross section taken in a direction orthogonal to a direction in which the inductor wiring extends, the second magnetic layer has an uneven shape that covers the inductor wiring from two directions parallel to the plane and one direction perpendicular to the plane.

<15> The inductor component according to any one of <1> to <14>, wherein, when the plane is viewed in a perpendicular direction, at least one of the first magnetic layer and the second magnetic layer is disposed on an inner side from an outer periphery of the inductor component.

<16> The inductor component according to <14>, wherein a surface of an insulating layer covering the second magnetic layer and serving as an outermost surface of the inductor component is flat as compared to the second magnetic layer with the uneven shape.

<17> The inductor component according to any one of <1> to <16>, wherein when the inductor wiring extending along the plane is defined as a first inductor wiring, the inductor component further includes a second inductor wiring extending along a plane parallel to the plane, and a space between the first inductor wiring and the second inductor wiring is filled with an insulating material.

<18> The inductor component according to <12>, wherein, when the plane is viewed in a perpendicular direction, at least one of the first magnetic layer or the second magnetic layer overlaps the plurality of inductor wirings, a ratio between a dimension of an outer periphery in a direction of the first one of the anisotropy axes and a dimension of the outer periphery in a direction of a second one of the anisotropy axes is within a range greater than or equal to 0.5 and less than or equal to 1 (i.e., from 0.5 to 1).

<19> The inductor component according to any one of <1> to <18>, wherein, when viewed in cross section taken in a direction orthogonal to a direction in which the inductor wiring extends, end portions of the first magnetic layer and the second magnetic layer have inclined portions that are inclined with respect to the direction perpendicular to the plane.

<20> The inductor component according to any one of <1> to <19>, wherein the first magnetic layer and the second magnetic layer are inorganic magnetic layers, and the inductor component includes a magnetic composite portion, containing an organic resin and an inorganic filler, between the first magnetic layer and the second magnetic layer.

The above-described embodiments are illustrative in all respects and are not restrictive. Modifications and variations can be made by those skilled in the art as appropriate. The scope of the present disclosure is defined by the claims, rather than by the above-described embodiments. Further, the scope of the present disclosure includes modifications of the embodiments that fall within the scope of the claims and their equivalents.

What is claimed is:

1. An inductor component, comprising:
an inductor wiring extending along a plane;
pad portions at two ends of the inductor wiring;
perpendicular wirings extending perpendicularly to the plane from the pad portions; and
a first magnetic layer and a second magnetic layer that hold the inductor wiring therebetween in a direction perpendicular to the plane,
wherein
the first magnetic layer and the second magnetic layer have uniaxial magnetic anisotropy axes oriented in the same axial direction, and
the inductor wiring extends throughout an entire area in a direction not orthogonal to a first one of the anisotropy axes.

2. The inductor component according to claim 1, wherein
the first one of the anisotropy axes is an easy axis.

3. The inductor component according to claim 2, wherein
the inductor component has a shape of a substantially rectangular prism, and the easy axis aligns with a longitudinal direction of the rectangular prism,
the two ends of the inductor wiring are spaced apart in a direction of the easy axis, and
the pad portions at the two ends overlap at least partially when viewed in the direction of the easy axis.

4. The inductor component according to claim 1, wherein
the first magnetic layer and the second magnetic layer are each formed from a laminate body including inorganic insulating layers and inorganic magnetic layers, and a thickness of the first magnetic layer and the second magnetic layer in a direction orthogonal to the plane is smaller than a thickness of the inductor wiring.

5. The inductor component according to claim 4, wherein
the inorganic insulating layer is at a surface of each of the first magnetic layer and the second magnetic layer configured from the laminate body.

6. The inductor component according to claim 1, wherein
a plurality of conductive layers are at end surfaces of the perpendicular wirings that are in contact with the pad portions and at opposite end surfaces.

7. The inductor component according to claim 1, wherein
the perpendicular wirings extend through at least one of the first magnetic layer or the second magnetic layer.

8. The inductor component according to claim 1, wherein
side surfaces of the perpendicular wirings facing in a direction parallel to the plane are covered with an insulating layer.

9. The inductor component according to claim 1, further comprising:
an external terminal connected to any of the perpendicular wirings and extending along a plane parallel to the plane,
wherein the external terminal overlaps at least one of the first magnetic layer or the second magnetic layer when the plane is viewed in a perpendicular direction.

10. The inductor component according to claim 1, wherein
the first magnetic layer is on an inorganic substrate, and the perpendicular wirings extend through the inorganic substrate.

11. The inductor component according to claim 1, wherein
the perpendicular wirings extend on two sides of the inductor wiring.

12. The inductor component according to claim 1, comprising:
a plurality of inductor wirings each corresponding to the inductor wiring, and extending along the plane.

13. The inductor component according to claim 12, wherein
the inductor component includes an area in which the plurality of inductor wirings disposed along the plane are arranged parallel and an area in which the plurality of inductor wirings are not arranged parallel.

14. The inductor component according to claim 1, wherein
when viewed in cross section taken in a direction orthogonal to a direction in which the inductor wiring extends, the second magnetic layer has an uneven shape that covers the inductor wiring from two directions parallel to the plane and one direction perpendicular to the plane.

15. The inductor component according to claim 1, wherein
when the plane is viewed in a perpendicular direction, at least one of the first magnetic layer and the second magnetic layer is disposed on an inner side from an outer periphery of the inductor component.

16. The inductor component according to claim 14, wherein
a surface of an insulating layer covering the second magnetic layer and being an outermost surface of the inductor component is flat as compared to the second magnetic layer with the uneven shape.

17. The inductor component according to claim 1, wherein
when the inductor wiring extending along the plane is defined as a first inductor wiring, the inductor component further includes a second inductor wiring extending along a plane parallel to the plane, and a space between the first inductor wiring and the second inductor wiring is filled with an insulating material.

18. The inductor component according to claim 12, wherein
when the plane is viewed in a perpendicular direction, at least one of the first magnetic layer or the second magnetic layer overlaps the plurality of inductor wirings, a ratio between a dimension of an outer periphery in a direction of the first one of the anisotropy axes and a dimension of the outer periphery in a direction of a second one of the anisotropy axes is within a range of from 0.5 to 1.

19. The inductor component according to claim 1, wherein
when viewed in cross section taken in a direction orthogonal to a direction in which the inductor wiring extends, end portions of the first magnetic layer and the second magnetic layer have inclined portions that are inclined with respect to the direction perpendicular to the plane.

20. The inductor component according to claim 1, wherein
the first magnetic layer and the second magnetic layer are inorganic magnetic layers, and the inductor component includes a magnetic composite portion, containing an organic resin and an inorganic filler, between the first magnetic layer and the second magnetic layer.
